(19) United States
(12) Patent Application Publication
(10) Pub. No.: US 2025/0098646 A1
(43) Pub. Date: Mar. 27, 2025

(54) TWO-PART WINDOW-MOUNTED BIRD FEEDER

(71) Applicant: Richard Edwin Woods, Canterbury (GB)

(72) Inventor: Richard Edwin Woods, Canterbury (GB)

(21) Appl. No.: 18/832,508

(22) PCT Filed: Jan. 26, 2023
(86) PCT No.: PCT/GB2023/050164

§ 371 Date: Jul. 23, 2024

(30) Foreign Application Priority Data
Jan. 26, 2022 (GB) 2200997.1

(51) Int. Cl. A01K 39/014; A01K 39/04

(52) U.S. Cl. CPC A01K 39/014; A01K 39/04

(57) ABSTRACT

A two-part-window-mounted bird feeder 10 comprising a main body 12 including front wall 14, a rear wall, two side walls 18a, 18b and a roof 20, the main body 12 forming a housing of the bird feeder 10, a feeding tray 40 receivable into a receiving cavity 22 of the main body 12, a retaining mechanism 26 for removably retaining the feeding tray 40 to the main body 12, and attachment means 32 for attaching the main body 12 to a window.

The present invention relates to a two-part window-mounted bird feeder and particularly to a bird feeder with a removable feeding tray.

### BACKGROUND TO THE INVENTION

People who enjoy watching wild birds and who also want to attract more wildlife in their garden or surrounding area tend to put out food, especially in bird feeders. This allows them to be able to watch the birds feed. Feeding especially in seasons where there is shortage of food can increase the survival rates of birds all year round, allowing the wild bird population to remain stable.

However, wild bird populations have been suffering from trichomonosis in recent years, which is a disease caused by the protozoan parasite Trichomonas gallinae. This disease affects the back of the throat making it difficult for birds to swallow. This means that the birds may regurgitate food when feeding. The regurgitated food may then be eaten by another bird, and this can spread the disease around.

Garden bird feeders can contribute to the spread of trichomonosis among birds since diseased birds that visit the feeders may contaminate the food in the bird feeders, which then may be eaten by healthy birds giving them the disease. Other diseases may also be spread through transmission from bird feeders such as salmonella, which is a bacterial infection which is spread when birds eat contaminated food with droppings of infected birds, and aspergillosis which is caused by the Aspergillus fungus found in damp or wet seed mixtures.

A way to reduce the spread of the disease is to ensure that the bird feeders, specifically the feeding trays of bird feeders are regularly cleaned. However, cleaning bird feeders may not be as easy to do and people may be unwilling to clean them regularly.

Window-mounted bird feeders are mounted to the outside surface of a window, typically by suction cups.

To clean the feeding tray of a window-mounted bird feeder, the bird feeder may need to be unmounted from the window first. This means that the suction cups mounting the bird feeder to the window would also need to be taken off. However, the suction cups may not necessarily stick back on easily, without cleaning the window and the suction cups first. Over time, with repeated removal, the suction cups may become damaged and no longer work effectively to secure the feeder to the window.

Some existing window-mounted bird feeders have a removable tray of some description which can be removed without releasing the suction cups. However, the tray tends to be exposed to rain, and can easily be contaminated with bird droppings.

It is an object of the present invention to reduce or substantially obviate the aforementioned problems, and in particular to provide a bird feeder which keeps food dry, prevents birds from defecating on the food, and yet has a removable tray which is easy to remove and clean. Use of such a bird feeder will help limit the spread of disease in wild bird populations.

Another object of the present invention is to reduce the risk of contamination of drinking water in bird feeders thereby reducing the risk of birds contracting diseases from drinking contaminated water.

### STATEMENT OF INVENTION

According to a first aspect of the present invention there is provided a two-part window-mounted bird feeder comprising:
a main body, the main body forming a housing of the bird feeder, the main body including a roof, and one or more walls depending vertically from an underside of the roof, the wall(s) defining a receiving cavity with a downward-facing open end;
a feeding tray receivable into the receiving cavity of the main body by central alignment of the feeding tray and the downward-facing open end on a common central vertical axis and insertion of the feeding tray upwards, along the common central vertical axis, into the receiving cavity via the downward-facing open end;
a retaining mechanism for removably retaining the feeding tray to the main body; and
attachment means for attaching the main body to a window.

Since the feeding tray can be removed from the main body of the bird feeder, the bird feeder may further comprise a second feeding tray. The second feeding tray may be identical to the first feeding tray, and they can be used interchangeably. The second feeding tray may replace the first feeding tray when the first feeding tray is dirty and ready for cleaning. The second feeding tray may be received into the receiving cavity of the main body where the feeding tray is surrounded by the wall(s) of the main body depending vertically from an underside of the roof, while the first feeding tray is detached from the main body of the bird feeder for cleaning.

The central vertical axis of the feeding tray may extend from a base to an upper end of the feeding tray. The central vertical axis of the downward-facing open end may extend from the downward-facing open end to the roof.

The central vertical axis of the downward-facing open end may be substantially parallel to the one or more walls depending from the roof.

When the feeding tray and the main body are assembled, the central vertical axes of the feeding tray and downward-facing open end may extend in a vertical direction parallel to the wall(s) of the main body.

The feeding tray is inserted into the receiving cavity of the main body, by pushing the feeding tray upwards into the downward-facing open end of the receiving cavity. The retaining mechanism then holds the tray in place, preventing it from falling out of the receiving cavity.

As the feeding tray is inserted into the receiving cavity, the feeding tray slides through the downward-facing open end of the receiving cavity towards the underside of the roof.

In use, the feeding tray may contain or be filled with any type of nourishment or sustenance for birds. For example, the feeding tray may be filled with bird food such as seeds, grains, fruits, etc., or liquid such as water.

The feeding tray may be considered to be a bird food tray and/or a drink tray.

The feeding tray, when inserted into the cavity, is substantially enclosed and protected by the wall(s). The food is thus protected from rainwater and bird droppings. A supply of food is kept clean and dry, and made available to the birds but in a manner which prevents contamination by droppings. In addition, together, the wall(s) and roof of the main body may surround or enclose the feeding tray when the feeding tray is held in the receiving cavity. A substantial part of the feeding tray may fill or occupy the receiving cavity of the main body.

The feeding tray may, when inserted into the cavity, be positioned such that it closes the open end of the receiving cavity. The feeding tray may act as a bottom wall for the bird feeder.

The receiving cavity is enclosed by wall(s) of the main body and the roof. The wall(s) and the roof of the main body together form the housing of the bird feeder. Preferably, the main body may comprise four walls including a first wall, a second wall, a third wall and a fourth wall. The first wall may form a front of the main body, the second wall may form a rear of the main body, and the third wall may form a first side wall of the main body and the fourth wall may form a second side wall of the main body.

When the bird feeder is attached to a window, the second wall may face against the window pane, with the first wall facing away from the window.

The first wall and the second wall may have a first edge and a second edge. The first edge of the first wall and second wall may be connected to the roof i.e., an underside of the roof. The second edge of the first wall and second wall may be disposed opposite the first edge. The first edge of the first wall may have a shorter length than the second edge of the first wall. Furthermore, the first edge of the second wall may have a shorter length than a second edge of the second wall. The first wall and the second wall may substantially reduce in width from the second edge to the first edge. This avoids blocking the view of the bird feeder, e.g., from inside a house through the window, or from the outside of the house so that birds can be viewed while they feed at the bird feeder.

A retaining mechanism is provided for removably retaining the feeding tray to the main body. The retaining mechanism may be provided on the first wall of the main body. The retaining mechanism may be positioned centrally of a portion of the first wall. The retaining mechanism may be a resilient clip. This allows person cleaning the bird feeder to easily attach or detach the feeding tray from the main body since the retaining means is disposed at the front of the bird feeder.

The retaining mechanism may be positioned at and/or actuatable from the front of the main body. This provides easy access to the retaining mechanism, which makes the removal of the feeding tray from the main body easier when the feeder is wall-mounted.

The retaining mechanism may be a releasable mechanism such as a latch or a catch for holding or retaining the feeding tray within the receiving cavity of the main body. The retaining mechanism may be a single latch or catch.

The retaining mechanism may be biased in a retaining position.

A portion of the resilient clip may be substantially flush with the first wall of the main body, while the other portion may be a curved portion which protrudes out from the main body. The curved portion of the resilient clip allows the person cleaning the tray to easily handle the resilient clip. Furthermore, the resilient clip may include a holding section disposed in line with the second edge of the first wall of the main body for further holding and retaining the feeding tray within the receiving cavity of the main body. Advantageously, the retaining mechanism allows the feeding tray to be easily attached or detached from the receiving cavity of the main body.

The third wall and fourth wall of the main body may be disposed between the first wall and the second wall of the main body. One end of the third wall and fourth wall may adjoin a side of the second wall, and the other end of the third wall and fourth wall may adjoin a side of the first wall. The third wall and the fourth wall may be spaced apart forming the receiving cavity enclosed by the first, second, third and fourth walls.

The third wall and the fourth wall may have a first edge and a second edge. The first edge of the third wall and fourth wall may be connected to the roof i.e., an underside of the roof. The second edge of the third wall and the fourth wall may be disposed opposite the first edge. The second edge of the third wall and the fourth wall may terminate before the second edge of the first wall and the second wall of the main body providing a gap on the sides of the main body. This allows the feeding tray received within the receiving cavity of the main body to protrude from the third and fourth walls and provide access to food for the birds on either or both sides of the main body.

In some embodiments, the wall(s) of the main body may be directly connected or joined or fused to the underside of the roof. In other words, the wall(s) of the main body may be permanent fixed or attached to the roof.

When the feeding tray is inserted into the receiving cavity, an upper end of the feeding tray may be disposed near or at the underside of the roof.

Connection means may be provided on the second wall of the main body for connecting attachment means to the main body. This allows the main body to be attached to the window. The attachment means for attaching the main body to a window may be a suitable device that sticks or attaches to windows such as suction cups.

Because the feeding tray can be removed from the receiving cavity of the main body using the retaining mechanism without needing to detach the main body from the window, the attachment means such as suction cups do not need to be taken off from the window. Therefore, the window does not need repeated cleaning to reattach the suction cups, and the suction cups do not become prematurely damaged as a result of repeated detachment and reattachment. This means that the suction cups can maintain their position on the window for a longer time. This also makes the cleaning of the feeding tray easier since the main body does not need to be removed from the window first before the feeding tray can be detached from the main body for cleaning.

At least one perch may be provided on the main body of the bird feeder. The at least one perch may be disposed on a side of the main body between an inner side of the first wall, near the second edge and an inner side of the second wall, near the second edge. Preferably, two perches are provided, one on each side of the main body. The perch may be a cylindrical pin or rod that runs between the first and second walls of the main body.

In some embodiments, the at least one perch may be disposed at a leftmost or rightmost side of the main body between the second edge of the first wall and the second edge of the second wall.

In some embodiments, the or each perch may be integrally formed with the main body of the bird feeder.

The perch may be spaced away from the feeding tray. The perch allows the birds to stand on the main body of the bird feeder while feeding instead of stepping directly on the food in the feeding tray. This reduces the possibility of contaminating the food with bird droppings.

The roof may extend horizontally away from the main body to cover the perch and the feeding tray. The roof may extend beyond the wall(s) of the main body to form an overhang, covering and protecting the feeding tray from rainwater. The roof may be substantially planar and positioned to slope down towards the first wall of the main body to allow the rain to run off from the bird feeder.

The roof and the wall(s) of the main body may substantially cover and protect the feeding tray to prevent rain, objects or dirt from falling into the feeding tray and mixing with the food.

The feeding tray may include a hopper for storing food in the feeding tray. The hopper of the feeding tray may be formed of one or more walls. Preferably, the hopper comprises four walls including a first wall, a second wall, a third wall and a fourth wall. The first wall may form a front of the hopper, the second wall may form a rear of the hopper, and the third wall may form a first side wall of the hopper and the fourth wall may form a second side wall of the hopper.

The third wall and fourth wall of the hopper may be disposed between (or extend between) the first wall and the second wall of the hopper. One end of the third wall and the fourth wall may adjoin an end of the first wall. An opposite end of the third wall and the fourth wall may adjoin an end of the second wall. In another embodiment, a side inset from the opposite end of the third wall and the fourth wall may adjoin an end of the second wall forming a protrusion of the third wall and fourth wall. This allows the hopper to abut an inner surface of the second wall of the main body when the feeding tray is received in the receiving cavity of the main body without too much friction preventing the hopper from getting stuck in the receiving cavity of the main body.

Alternatively, a protrusion may be added to each end of the second wall instead of forming a protrusion using the ends of the third and fourth walls. This allows the width of the protrusion to be sized according depending on the size of the hopper.

The protrusion allows the rear wall of the hopper to be spaced apart from the rear wall of the main body thereby reducing friction between the walls. In addition, the protrusion provides space between the rear walls so that the connection means can be attached to the main body without the feeding tray or hopper of the feeding tray getting in the way.

The third wall and the fourth wall may be spaced apart forming a hopper cavity enclosed by the first, second, third and fourth walls of the hopper. The hopper cavity allows bird food to be stored within the hopper of the feeding tray.

The wall(s) of the hopper may have a first edge and a second edge. In use, a first edge of the wall(s) of the hopper may abut the underside of the roof of the main body. The second edge of the wall(s) of the hopper may be disposed opposite the first edge.

In some embodiments, when the feeding tray is inserted into the receiving cavity, an upper end of the hopper may be disposed near or at the underside of the roof. The hopper may substantially fill or occupy the receiving cavity of the main body.

The wall(s) of the hopper may extend in a direction parallel to the respective wall(s) of the main body.

The second edges of the first wall and second wall of the hopper may connect to a receiving tray of the feeding tray.

The second edge of the third wall and fourth wall of the hopper may connect to the receiving tray of the feeding tray. Together, the walls of the hopper may slope down towards the first wall of the hopper. The shape of the hopper allows the hopper to be received within the receiving cavity of the main body.

The third wall and/or fourth wall of the hopper may terminate within the receiving tray. In other embodiments, the third wall and/or fourth wall of the hopper may terminate before the receiving tray.

The feeding tray or receiving tray may be suitable for holding liquid such as water. The receiving tray may lack apertures in the base or lower portions of its external walls so that liquid cannot leak out.

The level of water stored within the hopper (or reservoir) may be higher than the level of water dispensed from the hopper into the receiving tray. In other words, the volume of liquid that can be held in the feeding tray is not restricted to the height of the rim where birds can drink from.

One or more protruding portions may be provided on the receiving tray of the feeding tray. The protruding portion(s) may protrude from the third and/or fourth walls of the main body. Each protruding portion may include a lip for retaining the food within the feeding tray. The lip prevents the food from falling out of the feeding tray thereby, preventing bird food from being wasted.

An upper end of the lip may have a substantially curvilinear shape. In other words, the upper part of the lip may taper or curve downwards towards the middle. This provides easier access to the feeding tray for the birds while still preventing the birds from stepping on the food in the feeding tray. In embodiments where third and fourth walls of the hopper terminate within the receiving tray, the third and fourth wall may include an aperture (which may be considered as a dispensing aperture) in the portion of the third and fourth walls provided in the receiving tray. This allows bird food and/or water to enter the protruding portion of the receiving tray from the hopper.

In an embodiment, the aperture of the hopper may substantially have the same height as the lip of the protruding portion. This allows bird food stored in the hopper to fill the receiving tray as the food is eaten by birds.

In another embodiment, the height of the aperture may be less than the height of the lip of the protruding portion (relative to the base of the feeding tray). Due to atmospheric pressure, this allows the water stored in the hopper to fill the receiving tray as the water is drunk by birds without overfilling the receiving tray thereby preventing water from being wasted from overflow.

A width of protruding portion of the feeding tray may be smaller than a body of a bird. This reduces the possibility of the birds to fit within the gap between the protruding portion of the feeding tray and the third and fourth walls of the main body. This prevents the birds from stepping on the feeding tray while feeding. This reduces the risk of bird droppings mixing and contaminating the food in the feeding tray.

A V-shaped projection towards the hopper cavity may be provided on the receiving tray of the feeding tray. This allows the bird food within the hopper to fall into each protruding portion of the receiving tray preventing the food from getting stuck in the middle of the receiving tray of the feeding tray where the birds cannot reach them to eat.

In one embodiment, the V-shaped projection may extend vertically substantially along a lower section of the hopper.

In other embodiments, the V-shaped projection may not be provided. The bird feeder may be made from a suitable material that would allow the birds to see the food and people to bird watch such as a transparent plastic material. The bird feeder may have a length of 20 cm and a width of 15 cm or less. This allows the bird feeder to have a substantially small size. The bird feeder is only big enough to store enough food that can last for a day or two. This means that the feeding tray can be removed regularly and replaced with a clean feeding tray thereby, reducing the spread of diseases in birds without wasting too much food.

According to a second aspect of the present invention there is provided a two-part window-mounted bird feeder comprising:
a main body, the main body forming a housing of the bird feeder, the main body including a roof, and one or more walls depending vertically from an underside of the roof, the wall(s) defining a receiving cavity with a downward-facing open end;
a feeding tray receivable into the receiving cavity of the main body;
a retaining mechanism for removably retaining the feeding tray to the main body; and
attachment means for attaching the main body to a window.

The second aspect of the present invention may include any feature or features of the first aspect of the present invention.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective view of a first embodiment of a main body of a two-part window-mounted bird feeder;

FIG. 2 shows a perspective view of a first embodiment of a feeding tray of the bird feeder;

FIG. 3 shows a perspective view of the main body and the feeding tray detached from each other from the embodiments in FIGS. 1 and 2;

FIG. 4 shows a perspective view of the feeding tray connected to the main body of the bird feeder from the embodiments in FIGS. 1 and 2;

FIG. 5 shows a front perspective view of second embodiments of the main body and feeding tray of the two-part window-mounted bird feeder;

FIG. 6 shows a rear perspective view of the embodiments from FIG. 5; and

FIG. 7 shows a rear perspective view of the feeding tray from the embodiments in FIGS. 5 and 6.

### DESCRIPTION OF PREFERRED EMBODIMENTS

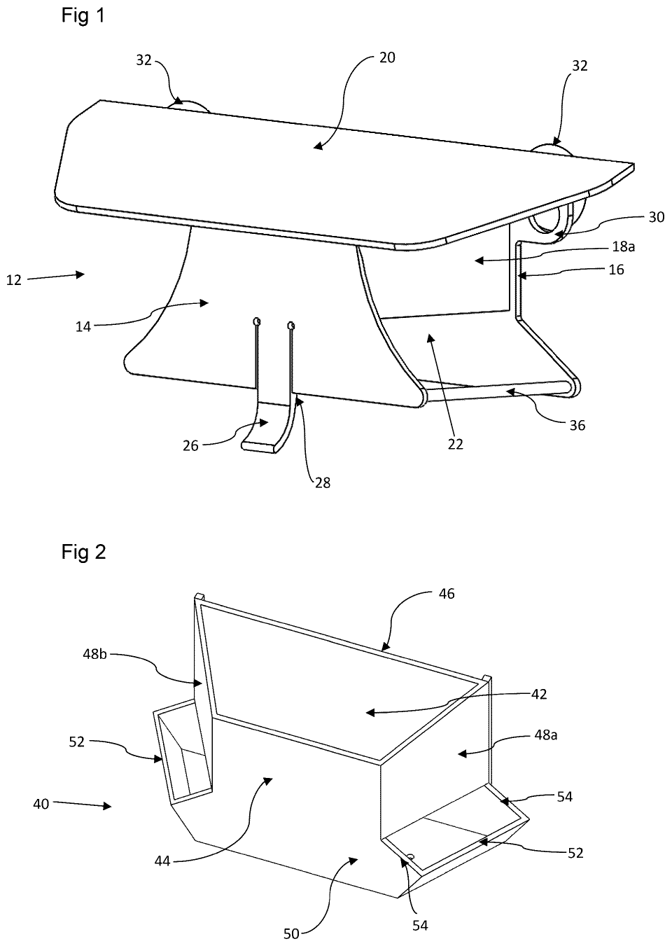

Referring firstly to FIG. 1, a perspective view of a first embodiment of a main body 12 of a two-part window-mounted bird feeder 10 is shown. The main body 12 comprises a front wall 14, a rear wall 16, a first side wall 18a, a second side wall 18b and a roof 20. The walls 14, 16, 18a, 18b of the main body 12 depend vertically from an underside of the roof 20 and define a receiving cavity 22 of the main body 12 with a downward-facing open end. The walls 14, 16, 18a, 18b and the roof 20 together form a housing of the bird feeder 10.

The walls 14, 16, 18a, 18b of the main body 12 have a first edge and a second edge. The first edges of the walls 14, 16, 18a, 18b of the main body 12 are connected to the underside of the roof 20. The second edges of the walls 14, 165, 18a, 18b of the main body 12 are disposed opposite the first edge of their corresponding wall.

The length of the front wall 14 increases gradually from its first edge to its second edge creating a smooth curve from the first edge to the second edge. A lower section of the rear wall 16 has an increased length compared to an upper section of the rear wall 16 whereby, the length tapers from a mid-portion of the rear wall towards the lower section of the rear wall 16. This prevents blocking the view of the bird feeder 10 so that people can watch birds feed from the feeding tray 10 from inside their house when the bird feeder 10 is attached to a window.

A retaining mechanism in the form of a resilient clip 26 is positioned centrally to a lower section of the front wall 14 of the main body 12. A portion of the resilient clip 26 is substantially flush with the front wall 14 while the other portion of the resilient clip 26 is a curved portion that curves away from the main body 12 as it protrudes out from the main body 12. The curved portion of the resilient clip 26 forms an operating handle and allows the person cleaning the tray to easily handle the resilient clip 26 to detach a feeding tray 40 (shown in FIG. 2) from the receiving cavity 22 the main body 12.

The resilient clip 26 has a holding section 28 disposed in line with the second edge of the front wall 14. This allows the feeding tray 40 to be held and retained in the receiving cavity 22 of the main body 12 further.

The side walls 18a, 18b of the main body 12 are both disposed between the front wall 14 and the rear wall 16 of the main body 12. One end of each side wall 18a, 18b adjoins a side of the rear wall 16 and the other end of each side wall 18a, 18b adjoins a side of the front wall 14. The side walls 18a, 18b of the main body 12 extend at an angle between the front wall 14 and the rear wall 16.

The second edges of the side walls 18a, 18b of the main body 12 terminate before the second edges of the front 14 and rear 16 walls. This creates a gap between the second edges of the side walls 18a, 18b and the second edges of the front 14 and rear 16 allowing the feeding tray 40 to protrude from the side walls 18a, 18b for providing access to food for birds on both sides of the bird feeder 10.

Connection means are provided on the rear wall 16 of the main body 12. In this embodiment, the connection means are two hooks 30. Each hook 30 is disposed at an end of the rear wall 16 next to the first edge of the rear wall 16. The connection means allows for the connection of attachment means such as suction cups 32 to the main body 12 of the bird feeder 10. This allows the main body 12 to be attached to the window.

Two perches 36 are provided, one on each side of the main body 12. Each perch 36 is a cylindrical rod or pin. One end of the perch 36 is attached to an end of the second edge of the rear wall 16 and the other end of the perch 36 is attached to an end of the second edge of the front wall 14. The two sides of the main body 12 of the bird feeder 10 are identical.

The second edge of the front wall 14 has a shorter length than the second edge of the rear wall 16. This allows the perch 36 to be positioned at an angle from the front 14 and rear 16 walls of the main body 12.

The roof 20 extends horizontally away from the main body 12 forming an overhang beyond the side walls 18a, 18b and allowing the perch 36 to be covered by the roof 20. The roof 20 is roughly planar and slopes down towards the front wall 14 of the main body 12 to allow the rain the run off from the bird feeder 10.

The roof 20 extends beyond the front wall 14 to form an overhang at the front of the feeder 10.

Referring to FIG. 2, a perspective view of a first embodiment of the feeding tray 40 is shown. The feeding tray 40 includes a hopper 42 for storing food in the feeding tray 40. Similar to the main body 12, the hopper 42 comprises a front wall 44, a rear wall 46 and a first side wall 48a and a second side wall 48b. The shape of the hopper 42 complements the shape of the main body 12 in that the hopper 42 can be slotted or received into the receiving cavity 22 of the main body 12. The hopper 42 is slotted upwards, into the receiving cavity 22 from underneath the main body 12 of the bird feeder 10, and is held in place by the holding section 28 of the resilient clip 26.

The walls 44, 46, 48a, 48b of the hopper have a first edge and a second edge. In use, the first edges of the walls 44, 46, 48a, 48b of the hopper abut the underside of the roof 20 of the main body 12 when the feeding tray 40 is received within the receiving cavity 22 of the main body 12. The second edges of the walls 44, 46, 48a, 48b of the hopper are opposite the first edges of the corresponding walls.

The hopper 42 substantially fills or occupies the receiving cavity 22 of the main body 12.

The side walls 48a, 48b of the hopper 42 are both disposed between the front wall 44 and the rear wall 46 of the hopper 42. One end of each side wall 48a, 48b adjoins an end of the front wall 16, and a side inset from an opposite end of each side wall 48a, 48b adjoins an end of the rear wall 14. The inset forms a protrusion of the side walls 48a, 48b at the rear of the hopper 42.

Overall, the hopper 42 has a trapezoid shape where the front wall 44 of the hopper 42 has a shorter length than the rear wall 46 of the hopper 42. An upper section of the hopper 42 slopes down towards its front wall 44, matching the slope of the roof 20 of the main body 12.

The second edges of the front 44 and rear 46 walls of the hopper 42 are connected to a receiving tray 50 of the feeding tray 40. The receiving tray 50 protrudes from the side walls 18a, 18b of the main body 12 when the feeding tray 40 is received into the receiving cavity 22 of the main body 12. The protruding portion of the receiving tray 50 includes a lip 52 for retaining the food within the feeding tray 40. This prevents the food from being wasted as they prevent the food from falling out of the feeding tray 40.

The second edges of the side walls 48a, 48b terminate before the receiving tray 50 thereby forming an aperture between the side walls 48a, 48b and the receiving tray 50 to allow food to pass from the hopper 42 into the receiving tray 50. However, in other embodiments, the aperture may be smaller. For example, when the side walls 48a, 48b terminate substantially within the receiving tray 50. When the feeding tray is received into the receiving cavity 22, the hopper 42 is surrounded by the front 14, rear 16 and side walls 18a, 18b of the main body 12. In use, the receiving tray 50 is disposed between the lower sections of the front 14 and rear 16 walls.

The bird feeder 10 can be made using a transparent material to allow the birds to see the food in the bird feeder 10. A transparent feeder allows the best view for bird watching from inside the house through the window where the bird feeder 10 is attached. The bird feeder 10 has a length of less than 20 cm and a width of less than 15 cm giving the bird feeder 10 a substantially small size so it can only store food that can last for a day or two. This means that the feeding tray 10 can be cleaned regularly, reducing the spread of diseases in birds without wasting too much food. This also means that the suction cups 32 can reliably support the weight of the feeder, even when full of feed.

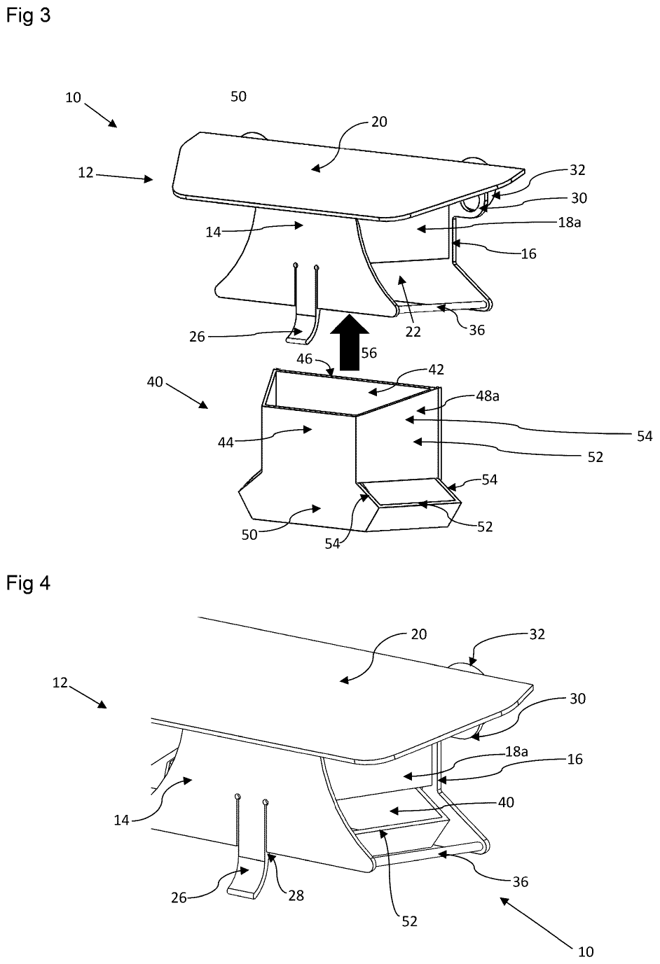

Referring to FIG. 3, a perspective view of the embodiments of the main body 12 and the feeding tray 40 of the bird feeder 10 from FIGS. 1 and 2 are shown with the feeding tray 40 detached from the main body 12. The feeding tray 40 can be slotted into the receiving cavity 22 of the main body 12 following direction 56. Note that the resilient clip 26 does not need to be separately pulled away from the front wall 14 or the main body 12 when slotting the feeding tray 40 into the main body 12. The holding section 28 may have a taper so that the action of inserting the feeding tray 40 pushes the clip 26 outwards, acting as a latch.

Referring to FIG. 4, a perspective view of the embodiments of the main body 10 and the feeding tray 40 of the bird feeder 10 from FIGS. 1 and 2 are shown with the feeding tray 40 attached to the main body 12. Once the feeding tray 40 is received into the receiving cavity of the main body 12 of the bird feeder 10, the feeding tray 40 is surrounded by the walls 14, 16, 18a, 18b and the roof 20 of the main body 12. The walls 44, 46, 48a, 48b of the hopper 42 abut or are very close (for example a clearance of 1-2 mm) to the respective walls 14, 16, 18a, 18b of the main body 12. A lip 54 on a front and rear of the receiving tray 50 abut the front 14 and rear 16 walls of the main body 12, respectively.

Overall, the resilient clip 26 allows the feeding tray 40 to be held within the receiving cavity 22 of the main body 12, where the walls 14, 16, 18a, 18b of the main body 12 surround the feeding tray 40. The resilient clip 26 is to be pulled away from the main body 12 to release the feeding tray 40 from the main body 12 when ready for cleaning.

The perch 36 is spaced away from the feeding tray 40. The perch 36 allows the birds to stand on the main body 12 of the bird feeder 10 while feeding, which can help to prevent the birds from stepping directly on the food in the feeding tray 40 and reduce the possibility of contaminating the food with bird droppings.

The roof 20 and the walls 14, 16, 18a, 18b of the main body 12 covers the feeding tray preventing rain, small objects or dirt from falling into the feeding tray 40 and mixing with the food. A small opening or access of food from the feeding tray 40 prevents birds from stepping on food and contaminating the food with their droppings.

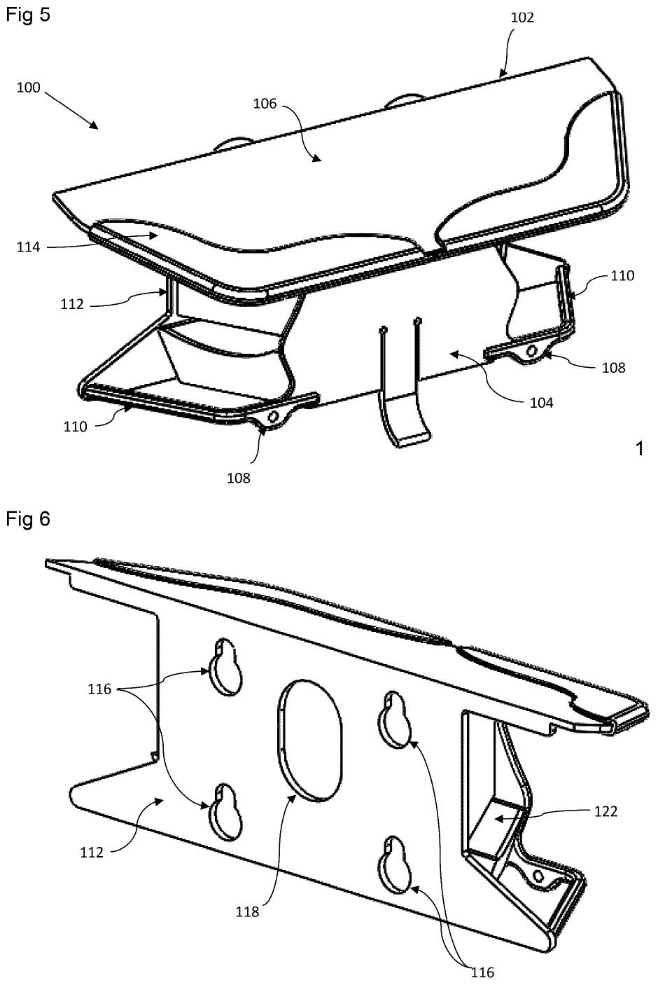

Referring to FIG. 5, a second embodiment of the main body 102 of the bird feeder 100 is shown. In this embodiment, a first edge of a front wall 104 connected to a roof 106 of the main body 102 has a shorter length than a second edge of the front wall 104 opposite the first edge of the front wall 104. The increase in length from the first edge to the second edge of the front wall 104 is not gradual but instead, the front wall 104 has shape similar to a bell.

A bracket 108 is connected to each end of the second edge of the front wall 104. The brackets 108 allow other things to be connected to the bird feeder 100 as desired. Each bracket 108 adjoins to an end of a perch 110. The other end of the perch 110 adjoins to an end of a second edge of a rear wall 112 opposite a first edge of the rear wall 112 connected to the roof 106. Each perch 110 is disposed at a side of the main body 102 between an end of the second edge of the rear wall 112 and a bracket connected to the front wall 104.

The second edge of the front wall 104 has a shorter length than the second edge of the rear wall 112 of the main body 102. This allows the perch 110 to be positioned at an angle from the front 104 and rear 112 walls of the main body 102.

The roof 106 of the main body 102 includes a cover 114 attached to a front section of the roof 106 next to the front wall 104 for decorative purposes.

An upper end of a lip (or rim) of each protruding portion of the receiving tray has a substantially curvilinear shape, wherein each lip curves downwards towards the middle. This allows birds to access food or water more easily from the feeding tray.

With reference to the embodiments in preceding figures, variations (not shown) of the feeding tray are contemplated. The side walls of the hopper may terminate at the base of the receiving tray. A dispensing aperture may be provided through each side wall at the base of the receiving tray. The height of the dispensing aperture may be lower than the rim of the receiving tray to allow the feeding tray to hold more water than the receiving tray alone could hold. The height of the dispensing aperture may be greater where the feeding tray is used to dispense food such as seeds or grain so that they can flow into the troughs more readily.

Referring to FIG. 6, connection means provided on the rear wall 112 of the main body 102. The connection means are keyhole shaped apertures 116. The keyhole shaped apertures 116 allow attachments means such as suction cups to be connected to the main body 102 of the bird feeder 100 for attaching the bird feeder 100 to the window. In this embodiment, four keyhole shaped apertures 116 are provided in the rear wall 112 of the main body 102 for connecting four suction cups. The increased number of suction cups allows the bird feeder 100 to be further securely attached to the window.

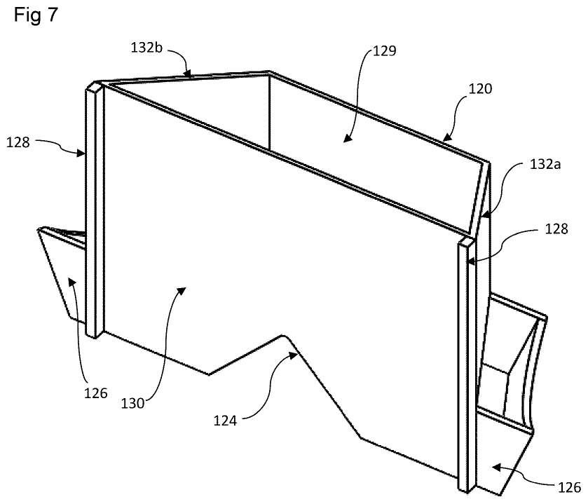

A rear aperture 118 is provided at the centre of the rear wall 112 of the main body 102. The rear aperture 118 further allows people watching from inside the house to see if the bird feeder 100 still has feed in a hopper 120 (shown in FIG. 7) of a feeding tray 122 requires replacing soon as there is not much feed left in the bird feeder 100.

The rear aperture 118 has a substantially oval shape.

Lastly, referring to FIG. 7, a V-shaped projection 124 is provided in a receiving tray of a feeding tray 122 extending towards a hopper cavity 129 of the hopper 120 of the feeding tray 122. This allows bird food within the hopper 120 to fall into the protruding portions 126 of the receiving tray too prevent the food from getting stuck in the middle of the feeding tray 122.

However, in other embodiments, the V-shaped projection may not be provided.

A protrusion 128 can be added to the ends of a rear wall 130 of the hopper 120 extending perpendicularly away from the rear wall 130 of the hopper 120 instead of creating a protrusion using the ends of side walls 132a, 132b of the hopper 120. This allows the protrusion 128 to be sized accordingly depending on the size of the hopper 120 allowing different sizes of hoppers to be held and retained within receiving cavity of the main body 102.

Moreover, the bird feeder enables both or either one of food or water to be provided to birds. The relatively small size of the bird feeder ensures that bird food and/or water are eaten or drunk by birds within short number of days. Therefore, the food or water is not kept in the feeder for long periods of time, keeping the nourishments fresh at all times. Furthermore, the bird feeder ensures that the food or water are completely surrounded or enclosed by the feeder which reduces the risk of contamination of food and/or water.

The embodiments described above are provided by way of example only, and various changes and modifications will be apparent to persons skilled in the art without departing from the scope of the present invention as defined by the appended claims.

1. A two-part window-mounted bird feeder comprising:
a main body, the main body forming a housing of the bird feeder, the main body including
a roof, and
one or more walls depending vertically from an underside of the roof, the one or more walls defining a receiving cavity with a downward-facing open end;
a feeding tray receivable into the receiving cavity of the main body by alignment of the feeding tray and the downward-facing open end on a common central vertical axis and insertion of the feeding tray upwards, along the common central vertical axis, into the receiving cavity via the downward-facing open end;
a retaining mechanism for removably retaining the feeding tray to the main body; and
attachment means for attaching the main body to a window.

2. The two-part window-mounted bird feeder as claimed in claim 1, further comprising a second feeding tray receivable into the receiving cavity of the main body while the first feeding tray is detached for cleaning.

3. The two-part window-mounted bird feeder as claimed in claim 1, in which the one or more walls of the main body comprise a first wall, a second wall, a third wall and a fourth wall, the first wall forming a front, the second wall forming a rear, the third wall forming the first side wall and the fourth wall forming a second side wall of the main body.

4. The two-part window-mounted bird feeder as claimed in claim 3, in which the second wall faces against a window pane and the first wall faces away from a window, when the bird feeder is attached to the window.

5. The two-part window-mounted bird feeder as claimed in claim 3, in which each of the wall(s) of the main body has a first edge connected to the roof and a second edge opposite the first edge, and in which the first wall and the second wall of the main body substantially reduce in length from the second edge to the first edge.

6. (canceled)

7. The two-part window-mounted bird feeder as claimed in claim 1, in which the retaining mechanism is a resilient clip.

8. The two-part window-mounted bird feeder as claimed in claim 7, in which the resilient clip includes a holding section for further holding and retaining the feeding tray within the receiving cavity of the main body.

9. The two-part window-mounted bird feeder as claimed in claim 3, in which the third wall and the fourth wall of the main body are disposed between the first wall and the second wall.

10. The two-part window-mounted bird feeder as claimed in claim 3, in which each of the walls of the main body has a first edge connected to the roof and a second edge opposite the first edge, and in which the second edge of the third wall and the fourth wall terminate before the second edge of the first wall and the second wall of the main body.

11. The two-part window-mounted bird feeder as claimed in claim 3, in which a connection means is provided on the second wall of the main body for connecting the attachment means to the main body.

12. The two-part window-mounted bird feeder as claimed in claim 1, in which the attachment means is a suction cup.

13. The two-part window-mounted bird feeder as claimed in claim 1, in which at least one perch is provided on the main body, the at least one perch being spaced away from the feeding tray.

14. (canceled)

15. The two-part window-mounted bird feeder as claimed in claim 1, in which the roof extends beyond the one or more walls defining of the main body forming an overhang.

16. The two-part window-mounted bird feeder as claimed in of claim 3, in which the roof is substantially planar and positioned to slope down towards the first wall of the main body.

17. The two-part window-mounted bird feeder as claimed in claim 1, in which the feeding tray includes a hopper for storing food.

18. The two-part window-mounted bird feeder as claimed in claim 17, in which the hopper comprises a first wall, a second wall, a third wall and a fourth wall, the first wall forming a front, the second wall forming a rear, the third wall forming the first side wall and the fourth wall forming a second side wall of the hopper.

19. The two-part window-mounted bird feeder as claimed in claim 18, in which one end of the third wall and the fourth wall adjoin an end of the first wall, and a side inset from an opposite end of the third wall and the fourth wall adjoin an end of the second wall forming a protruding end of the third wall and the fourth wall.

20. The two-part window-mounted bird feeder as claimed in claims 18, in which a second edge of the third wall and fourth wall of the hopper connect to a receiving tray of the feeding tray.

21. The two-part window-mounted bird feeder as claimed in claim 18, in which one or more protruding portions are provided on the receiving tray of the feeding tray, the one or more protruding portions including a lip for retaining food within the feeding tray.

22. (canceled)

23. The two-part window-mounted bird feeder as claimed in claim 20, in which a V-shaped projection towards the hopper is provided on the receiving tray.

24. (canceled)

25. (canceled)
